(19) United States
(12) Patent Application Publication
(10) Pub. No.: US 2025/0325158 A1
(43) Pub. Date: Oct. 23, 2025

(54) ADHESIVE RELEASE STRIP DIRECTOR

(71) Applicant: Richard Buelna, Cedar Hill, TX (US)

(72) Inventor: Richard Buelna, Cedar Hill, TX (US)

(21) Appl. No.: 19/185,125

(22) Filed: Apr. 21, 2025

Related U.S. Application Data
(60) Provisional application No. 63/637,134, filed on Apr. 22, 2024.

(51) Int. Cl. A47L 9/02; A47L 9/28

(52) U.S. Cl. CPC A47L 9/02; A47L 9/2836

(57) ABSTRACT

An automated system for efficient adhesive release strip collection and containment. The invention protects the environment from release strip waste, the packaging facility from loose release strips, which create hazards for workers and additional work for custodians. The invention comprises a structurally adaptable Head Unit with a plenum and manifold, strategically arranged exhaust ports creating a vacuum and vortex effect. The induced airflow travels at significant velocity and entrains air creating a slight vacuum at the opening. Combined with entrainment, the hollow shape causes a slight vacuum, which pulls the adhesive release strips into the induced airflow. The adhesive release strips are then forced to the opposite end, or bottom of the ARSD, where strips can be contained. A high-static pressure Airflow Delivery System directs adhesive waste into a secure Containment System, mitigating environmental and workplace hazards, and operational downtime, and ensuring cleanliness and efficiency in packaging processes.

### FIELD OF THE INVENTION

The present disclosure relates generally to the system for collecting waste products from packaging materials.

### BACKGROUND

Many consumers prefer to shop from the comfort of home due to time constraints on their schedule, mobility, ability to shop when physical retail store locations are closed, and other reasons. Many of these purchases are delivered in boxes, but others are delivered in envelopes. Some envelopes, cartons, and polybag mailers have embedded adhesives to seal the packaging, which includes an adhesive release strip. The adhesive release strip is removed to seal the envelope, and the exposed surface is pressed onto the package to seal it. Millions of these envelopes are shipped daily, and billions annually. The adhesive backing strips are an unfortunate waste product of this convenience of daily life. Waste is the last thing on the minds of most consumers. Waste can be ignored until it accumulates and starts to cause issues. The same is true for businesses that generate tons of waste. As e-commerce becomes the norm today, the amount of waste continues to increase and shows no signs of slowing down. Consumers need a way to contain these types of waste before it becomes a nuisance and danger.

With the exponential growth of e-commerce and shipping, adhesive-sealed packages and their adhesive release strips present a significant waste challenge. Strips are lightweight, electrostatic, non-biodegradable, and cause operational disruptions, workplace hazards, and environmental concerns. Manual disposal methods are inadequate, requiring automation for effective management.

Adhesive release strips are lightweight, can become electrostatically charged, stick to everything, and are primarily nonbiodegradable. The adhesive release strip is manufactured with non-biodegradable materials. Adhesive release strips are necessary to protect the adhesive that seals the packages to protect the contents and prevent those contents from falling out of the packages.

Thin plastic, thin paper, and bimetal strips tend to become electrostatically charged. This property hinders the ability to control the strips for proper containment and disposal. They stick to other articles of plastic, equipment, and even ourselves. In the fast-paced environment of e-commerce and shipping warehouses, many person-hours are employed to contain and dispose of these waste articles.

The adhesive release strips are currently placed in waste receptacles; however, due to the electrostatic nature of the materials from which adhesive release strips are manufactured and the speed at which e-commerce companies operate, the placement of each adhesive release strip into a waste receptacle becomes tedious and negligible. The adhesive release strips are commonly swept up, vacuumed, and picked up by hand. These adhesive backing strips may get blown around a warehouse and clog conveyance machinery, resulting in hours or days of delay while the strips are individually removed and machinery repaired. Strips may also be blown or float onto the ground, creating a constant mess for custodial staff. The strips may also present safety hazards if an employee steps or slips on the adhesive strip waste. These are all hazards caused by the strips inside the warehouse. The adhesive release strips are also an eyesore. Businesses that generate large amounts of waste should be conscientious of their neighbors and the neighborhoods in which they operate.

The strips are also responsible for environmental hazards when released or escaping into the environment. The strips can find their way into neighboring buildings' water sources, sewers, vents, and parking lots. Due to their composition of cheap plastics, bi-metal foils, and coated papers, they are not biodegradable. They will continue to wreak havoc for years as they blow around warehouses, landfills, neighborhoods, and water sources. Birds may inadvertently mistake these adhesive release strips for nesting material and may inadvertently ingest this material. If adhesive release strips entered the ocean, which all indications suggest at the current impact rate, fish and other wildlife may also be impacted.

The ARSD solves the environmental consequences of allowing nonbiodegradables, highly electrostatically inducive, concerning the bimetallic backing strips, plastics, and paper waste generated from heavy parcel-driven commerce.

The ARSD was invented to assist in adequately mitigating waste that has never been given any thought, such as adhesive release strips. The adhesive release strip director and proper containment will help prevent pollution in our ecosystem. The problem being solved by the ARSD is the lack of control of packaging waste.

The ARSD System effectively resolves adhesive strip waste issues by automating the collection, enhancing operational efficiency, safety, and environmental protection, adaptable to diverse industrial settings.

### OBJECTIVES

An object of the present disclosure is to retain adhesive release strip backing when separated from the primary packaging.

Another object of the invention is to protect the environment from adhesive strip backing waste.

Another object of the invention is to prevent workplace safety hazards caused by adhesive strip backing.

Another object of the invention is to avoid damage to machinery from adhesive strip backing interfering with machinery reliability.

### SUMMARY

The present invention relates to an Adhesive Release Strip Director (ARSD) System designed to automate the efficient collection and containment of adhesive release strips, addressing a significant waste management issue in high-volume shipping environments. The ARSD leverages Bernoulli's Principle as airflow exiting the exhaust ports creates a slight vacuum effect, entraining adhesive strips into the airflow and directing them into a containment device without manual intervention. This invention securely captures and stores adhesive strips, utilizing permeable mesh containers, effectively maintaining workplace cleanliness and protecting the environment from this waste product. The ARSD comprises three primary system assemblies: (1) a Head Unit; (2) an Airflow Delivery System (AFD) and (3) a Containment System.

The Head Unit is the core structural assembly, which includes an Intake Port, leads airflow into an internal channel, a Plenum accumulates incoming high-velocity airflow and a Manifold, to direct airflow through precisely arranged Exhaust Ports, which are a series of directional holes at the top of the manifold unit. These components create a toroidal vortex and vacuum effect based on Bernoulli's fluid dynamics principles that attracts light weight waste products, such as adhesive release strips, into the hollow center opening of the ARSD head unit. The design of the manifold increases the rigidity of the shell, whereas the shape of the ARSD may resemble a hollow donut. The configuration may take the shape of a rectangle, circle, or square, provided that the interstitial space permits the passage of air. The Head Unit shape can be constructed in any 3-dimensional geometric form, such as cube, torus, rectangular prism, or cylinder. Interstitial space within the body of the ARSD's Head unit must be maintained to create a sealed envelope, like a hollow donut, which channels airflow to strategically placed Exhaust Ports on the body of the head unit. An air intake port, leads to the plenum, which collects and contains the high velocity air from the air flow delivery system, directs the air flow to a manifold. This manifold has strategically arranged exhaust ports and an internal cross section that maximizes air velocity, and airflow efficiency at the point of exhaust. The exhaust airflow is expelled normal vector to plane of the material intake to the head unit body. The resulting exhaust entrains air at the material intake side of the head unit, resulting in a slight vacuum as observed by Bernoulli's fundamental laws of fluid dynamics. Once introduced into the airstream, the adhesive release strips are carried via air current to the containment system. The head unit may have several variations of mounting styles incorporated into the body specific to the ARSD's intended work deployment which may include, but is not limited to, screws, bolts, and adhesives.

The structural rigidity is attained by its geometric configuration, which generates a wall thickness that inhibits the ingress of air. The development of air pressure is necessary in order to direct it in a specific velocity and direction, hence facilitating the accomplishment of the containment work. The Head Unit shape, and the arrangement of the exhaust ports determine the efficacy at which the work is derived when high velocity airflow from the airflow delivery system is supplied and forced out of the exhaust ports. The main principle at work is a toroidal vortex. The Head unit is supplied high velocity airflow from the Airflow Delivery system. The Airflow Delivery System is comprised of a fan unit, capable of delivering high static pressure airflow to the head unit, and a control system, for diverting airflow or, switching the fan on and off when necessary, through the use of integrated controls. The Containment System, which is secured at the exhaust side of the Head Unit in its simplest form, can be any open mesh container, whose mesh is smaller than that of the material being contained so that the collected waste materials will not slip through mesh holes. The mesh material ensures that the exhaust can be diffused and that the collected waste material, in this case, the adhesive release strips generated from shipping materials, is deposited within the containment system.

The Airflow Delivery System (AFD) supplies controlled, high-static pressure airflow, which includes a high-Static Pressure Fan Unit similar to devices used in leaf blowers or hair dryers. The Control Systems incorporate electronic sensors, integrated controls, power management, and safety components. The AFD is also adaptable as a standalone or centralized multiunit system. The fan can be directly integrated into the manifold, which is how the current embodiment is configured, or by default, a stand-alone unit which feeds multiple Head units (manifold and plenum) systems through ductwork or plumbing from head unit to stand alone AFD. If the fan is integrated into the manifold, the control would be a power supply, drivers for the fan, power on and off, and any type of actuating sensor that switches the fan on and off with programmable timing, analogous or digital. An alternative version of ARSD is made of an actuating valve for the stand-alone system. This valve, which would align with the ductwork before the manifold and open and close rapidly, that is actuated by a sensor. Possible PIR or passive infrared sensors, such as hand-swiping paper towel dispensers, or standard infrared sensors that detect the presence of heat, such as touch sensors. The Plenum receives high-flow air from the airflow delivery system and distributes it to the Manifold through integration with the Plenum. The different configurations of the ARSD will require varying specifications of these types of fans to complete the work. The type of containment system and ductwork used will also dictate the specification of the fan unit. An integrated fan will have a smaller footprint than a stand-alone unit that will be manifolded to multiple units. The stand-alone system will need to be much larger with a high CFM (cubic foot per minute) output to overcome the distances and plumbing configuration of the system setup. A stand-alone high static pressure fan can be mounted at a distance and plumbed to multiple manifolds.

The airflow delivery system is a high static pressure fan whose output is determined by the manifold and plenum's shape, size, and arrangement. The airflow delivery system is composed of off-the-shelf components, including its Fan and electronics for control, that meets the minimum requirements of the plenum and manifold arrangement. A more significant number of vents and a larger manifold would require a higher output fan unit because the velocity of the airflow through the unit must maintain a minimum air velocity. Maintaining a minimum airflow velocity through the system is essential for proper control of the adhesive release strips into containment. When the system has more vents and a larger plenum, the airflow velocity may decrease due to the increased cross-sectional area of the plenum and manifold. As a result, a higher output fan unit may be required to maintain the desired airflow velocity. The fan is controlled by a PIR sensor, timer, and power supply, which are generic electronic controls. Airflow can be piped or ducted to the plenum by any means to provide the minimal requirements of the ARSD. Air is introduced into the plenum, distributed to the manifold via an internally hollow shape, and forced out of the vents at a downward, catty-corner arrangement. The induced airflow travels at significant velocity and entrains air from the opening of the ARSD, creating a slight vacuum at the ARSD's opening or top. Combined with entrainment, the shape causes a slight vacuum, which pulls the adhesive release strips into the induced airflow. The adhesive release strips are then forced to the opposite end, or bottom of the ARSD, where further processing of the strips can be accomplished. The central machinery or workstation usually has a waste receptacle beneath the machine, which has an opening on the surface of the workstation through which the strips are manually placed. Due to plastics' lightweight and electrostatic nature, the adhesive release strips don't always make it into the receptacle. The ARSD is mounted above the receptacle, or containment system in any configuration. The current design snaps around an opening on the workstation's surface. The ARSD can be used as a standalone device, not necessarily mounted or attached to the machinery or work surface.

The Airflow delivery system can be fabricated with easily accessible components, as long as certain criteria are meet. The main component of the AFD is the blower fan. This will have to be a high static pressure fan, such as that found in a hairdryer or garden blower. An enclosure will be necessary to mount the various controls and fan unit. A system of control, will need to be developed, this includes power supply, sensors that detect movement for autonomy, proper voltage regulation, and any safety features based on the ARSDs intended implementation. The fan size will need to meet or exceed the requirements of the head unit in either a standalone or multiunit system. Controls for the fan are negligible on a multiunit system as the fan would be running at a constant from a remote location adjacent to the work stations. As for an integrated system, integrated controls will need to be designed as a constant high static pressure fan would become a nuisance to the operators during sustained run times. Integrating microcontrollers, microprocessors, or solid-state electronic controls are all feasible. In the standalone AFD system, an enclosure, and mounting solutions will need to be deployed. A multiunit system will require specialized valving, piping, and controls to draw out the most efficiency from the fan unit chosen, as well as a different control recipe for efficient and reliable operation.

Several other components can be integrated into ARSD, such as duct work, actuating valves, infrared or swipe sensors, switching devices, integrated controls, and containment systems. The integration of PIR, IR, or touch sensors facilitates the efficiency of the ARSD and its reliability in terms of potential use in high-production facilities. Using high-pressure fans also introduces high-pitched frequency sounds, which are undesirable in workplaces. Integrating these controls would cycle the ARSD on and off when needed rather than allowing the unit to run continually. The airflow delivery system can be stand-alone and have the fan and controls mounted in a singular unit, or manifolded and airflow distributed to multiple ARSDs units. The ARSD is the main machine, and several units, depending on the ability of the airflow delivery system specification, several ARSD can be ducted to the airflow delivery system. In the current embodiment, the airflow delivery system is integrated into the unit. The ARSD can be plumbed in or connected to a network of ductwork or tubes supplying the air such that the ARSD is integrated into existing air supply systems, enabling expedient deployment. The Containment System is positioned at the exhaust side of the Head Unit attached to the integrated containment system cleat, to effectively capture adhesive strips, which includes an Open Mesh Container that allows exhaust airflow diffusion, a secure attachment via integrated cleats, hooks, or suitable fastening mechanisms. The containment system in this embodiment is a mesh bag with a cord cinch and lock mechanism that can be secured to the integrated cleat or lip on the exit side of the head unit of the ARSD. The open nature of the mesh container allows for the high velocity exhaust to be diffused, thus maintaining the collected material securely enclosed in the containment envelope for further processing. A container with the same openings, box, bag, or anything that allows air to pass through and allows accumulation of the adhesive release strips can be used in place of the mesh bag. The containment system can also be plumbed into a separate waste disposal system for further processing of the adhesive release strips. This can increase dimensions of the space available for waste strip storage eliminating the need for bags or boxes for containment.

### BRIEF DESCRIPTION OF DRAWINGS

For a more complete understanding of this disclosure and its features, reference is now

made to the following description, taken in conjunction with the accompanying drawings in which:

FIG. 1 shows an interior view of the conceptual Head Unit of the ARSD.

FIG. 2 shows a multi-unit conceptual embodiment of the ARSD.

FIG. 3 shows a top view of the integrated design of ARSD.

FIG. 4 shows a side view of the integrated design of ARSD.

FIG. 5 shows a side view of the integrated design of ARSD.

FIG. 6 is shows a front view of the integrated design of ARSD.

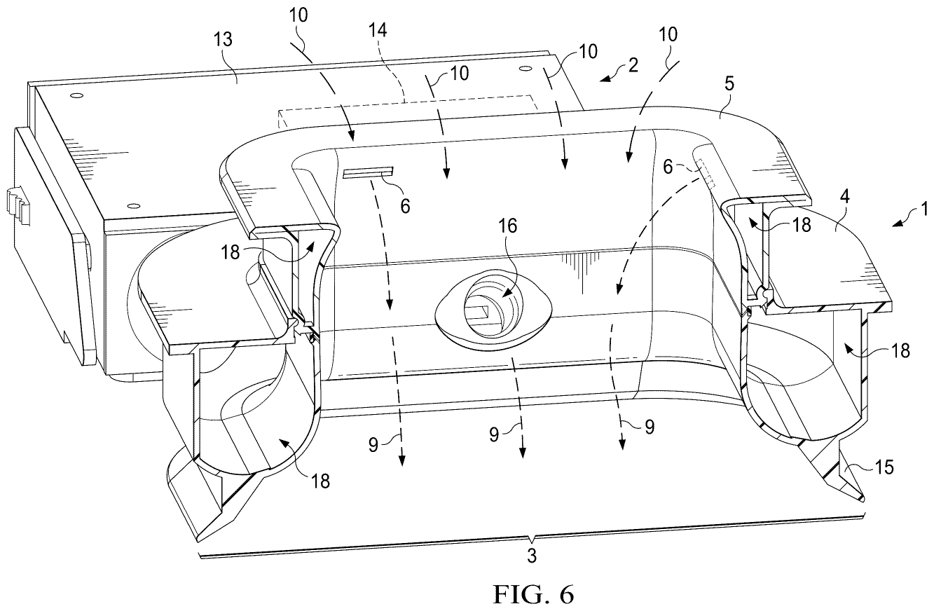

### REFERENCE NUMBERS

1 Head Unit
2 Airflow Delivery System (integrated)
2a Airflow Delivery System (stand alone)
3 Containment System (not shown)
4 Plenum
5 Manifold
6 Exhaust Ports
7 Air intake port
8 Material Intake
9 Exhaust to Containment System
10 Entrained airflow
11 forced airflow from AFD
12 high velocity fan motor
13 electronics and controls enclosure
14 controls mounting area/unit interface
15 integrated containment system Cleat
16 Sensory Equipment
17 Internal Control wiring port
18 Interstitial space
19 Containment envelope
20 Plumbing to head unit (integrated controls)

### DETAILED DESCRIPTION OF DRAWINGS

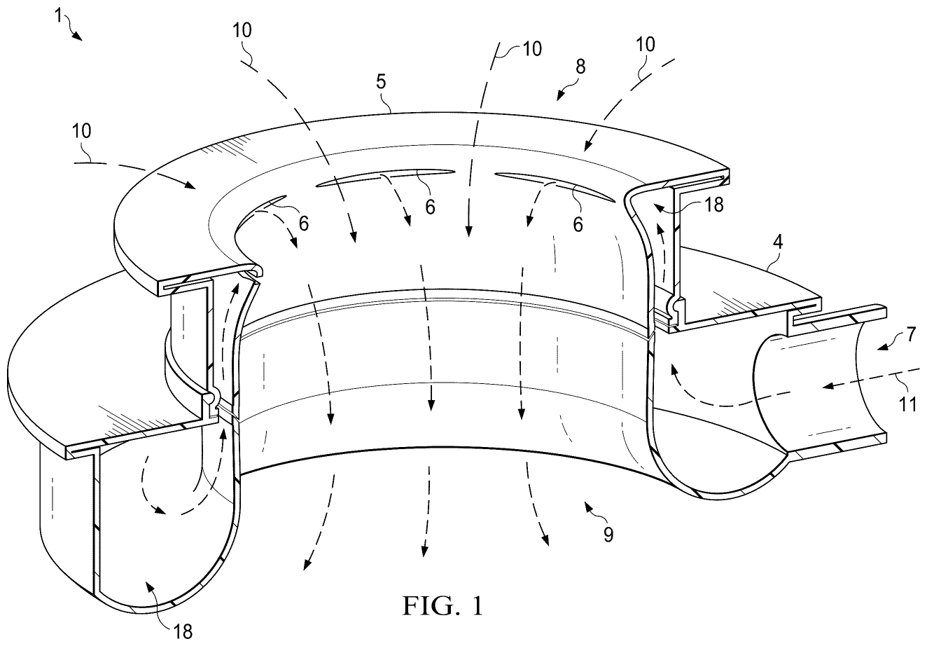

FIG. 1 shows the head unit 1, which includes an Intake Port 7 and leads airflow into an internal channel, a Plenum 4 distributes incoming high-velocity airflow and a Manifold 5 directing airflow through precisely arranged Exhaust Ports 6. Interstitial space 18 with in the body of the ARSD's Head unit 1 must be maintained to create a sealed envelope, like a hollow donut, which channels airflow to strategically placed Exhaust Ports 6 on the body of the head unit 1. An intake port, leads to the plenum, which collects and contains the high velocity air from the air flow delivery system 11, directs the air flow to a manifold. This manifold has strategically arranged exhaust ports 6 and an internal cross section that maximizes air velocity, and airflow efficiency at the point of exhaust. The exhaust airflow is expelled normal vector to plane of the material intake to the head unit body. The resulting exhaust entrains air 10 at the material intake 8 side of the head unit. Once introduced into the airstream, the adhesive release strips are carried via air current to the containment system. The material intake 8 with exhaust airflow is expelled to the containment system 9 located beneath the head unit 1, where the material intake 8 is caught in the containment system while the exhaust airflow passes through the mesh containment system.

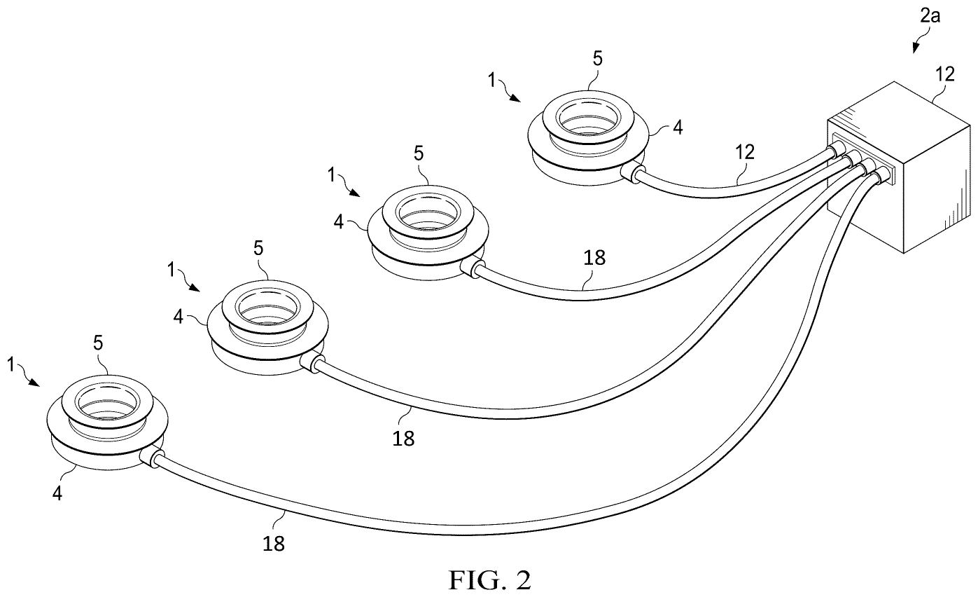

FIG. 2 shows a multi-unit embodiment of the ARSD. A high velocity motor fan 12 is connected to a number of tubes or plumbing 20. The tubes 20 connect to the head unit 1 on one end and the high velocity motor fan 12 on the opposite end of the tubes 20. The plenum 4 and manifold 5 combine to form the head unit 1. The fan size will need to meet or exceed the requirements of the head unit in either a standalone or multiunit system. Controls for the fan are negligible on a multiunit system as the fan would be running at a constant from a remote location adjacent to the work stations. In the standalone AFD system 2a, an enclosure, and mounting solutions will need to be deployed to operate the multi-unit embodiment of ARSD.

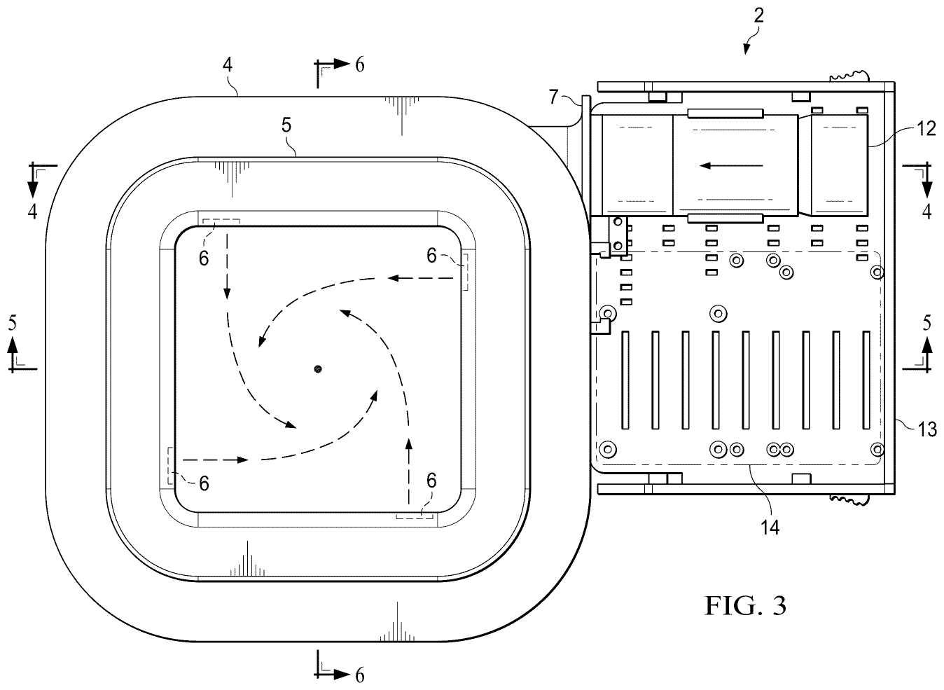

FIG. 3 shows a top view of the integrated design of ARSD. The head unit 1, which includes an Intake Port 7, leads airflow into an internal channel, a Plenum 4, which distributes incoming high-velocity airflow and a Manifold 5 directing airflow through precisely arranged Exhaust Ports 6. Airflows out of the exhaust ports, carries material intake through the head unit and into the containment system. The high velocity fan motor 12 and unit interface for controls mounting 14 are housed in the electronics control enclosure 13. In this view, the integrated airflow delivery system 2 is shown, attached to the head unit 1.

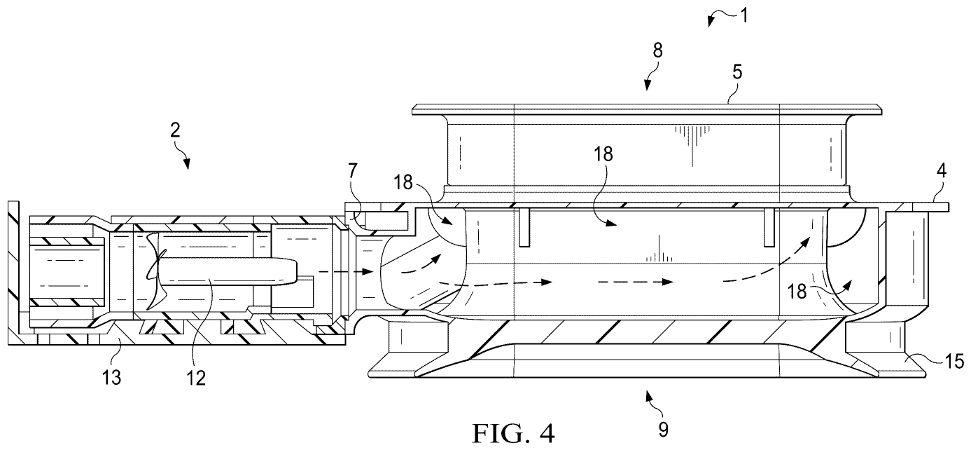

FIG. 4 shows a side view of the integrated design of ARSD. The head unit 1, which includes an Intake Port 7, leads airflow into an internal channel, a Plenum 4, which distributes incoming high-velocity airflow, is connected to a Manifold 5. The head unit 1 is integrated with the airflow delivery system 2. The high velocity fan motor 12 is housed in the electronics control enclosure 13 of the airflow delivery system 2. Interstitial space 18 with in the body of the ARSD's Head unit 1 must be maintained to create a sealed envelope, like a hollow donut, which channels airflow to strategically placed Exhaust Ports 6 on the body of the head unit 1. The material intake 8 with exhaust airflow is expelled to the containment system 9 located beneath the head unit 1, where the material intake 8 is caught in the containment system while the exhaust airflow passes through the mesh containment system.

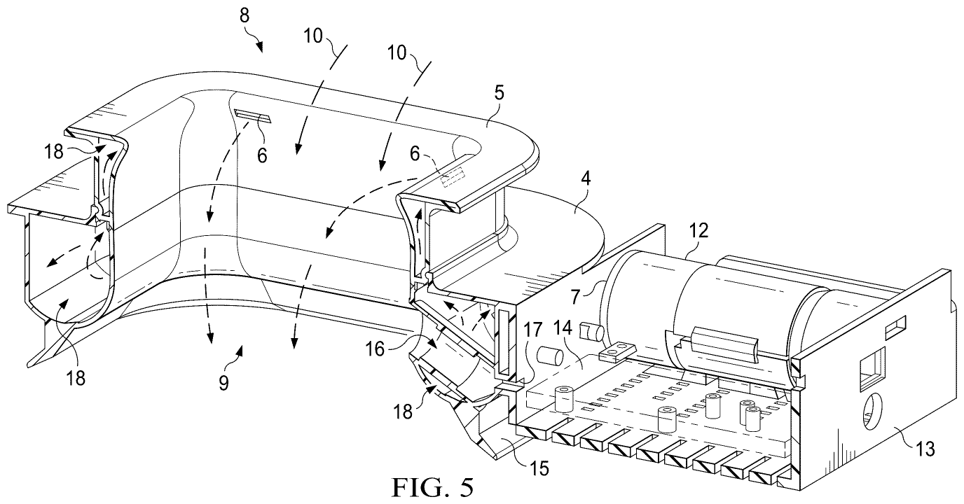

FIG. 5 shows a side view of the integrated design of ARSD. The head unit, which includes an Intake Port 7, leads airflow into an internal channel, a Plenum 4, which distributes incoming high-velocity airflow, is connected to a Manifold 5. The head unit 1 is integrated with the airflow delivery system 2. The resulting exhaust entrains air 10 at the material intake 8 side of the head unit. The high velocity fan motor 12 and unit interface for controls mounting 14 are housed in the electronics control enclosure 13 of the airflow delivery system 2. Interstitial space 18 with in the body of the ARSD's Head unit 1 must be maintained to create a sealed envelope, like a hollow donut, which channels airflow to strategically placed Exhaust Ports 6 on the body of the head unit 1. The material intake 8 with exhaust airflow is expelled to the containment system 9 located beneath the head unit 1, where the material intake 8 is caught in the containment system while the exhaust airflow is diffused through the containment system 9. The embodiment shown includes an integrated containment system cleat 15 that can be used to attach the embodied containment system design to the head unit, if the ARSD is mounted in a free form manner, not necessarily on a surface as this invention embodies. The sensory equipment 16 can be a PIR, break beam or hand swipe or any other device that can sense the presence of materials for intake and activate the ARDS's airflow. The internal control wiring port 17 is a sealed passage that allows control related wiring to be run through the plenum of the ARSD while maintaining a sealed envelope of the head unit.

What is claimed is:

1. A system for collection of adhesive release strip waste from packaging comprised of:
a head unit comprised of a manifold connected to a plenum,
wherein said manifold that is further comprised of an exterior surface and interior surface, wherein a first area of interstitial space is located between said exterior surface of said manifold and said interior surface of said manifold,
wherein said plenum that is further comprised of an air intake port at the exterior surface of said plenum and a second area of interstitial space between said exterior surface of said plenum and an interior surface of said plenum,
airflow delivery system comprised of a high velocity fan and electronic control board, and
containment system.

2. The system of claim 1, wherein said high velocity fan of said airflow delivery system is connected to said air intake port at the exterior surface of said plenum.

3. The system of claim 2, wherein said head unit further contains a hollow central opening between said manifold and said plenum, wherein a series of exhaust port holes are located at the top surface of said central opening, wherein said exhaust port holes are angled downward, toward said central opening of said head unit.

4. The system of claim 3, wherein said air intake port of said plenum is connected to said high velocity fan located in an electronic control housing unit, wherein said electronic control housing unit contains an electronic control board.

5. The system of claim 4, wherein said electronic control board houses integrated circuitry for the functionality selected from the group consisting of: starting air flow, stopping airflow, diverting airflow, electric power management, actuating sensor, programmable timer, and safety components.

6. The system of claim 5, wherein a sensory mechanism is located at the connection point of said manifold and said plenum.

7. The system of claim 6, wherein said sensory mechanism is selected from the group consisting of: passive infrared sensor, beam sensor, touch sensor, heat sensor, and hand swipe sensor.

8. The system of claim 7, wherein air directed through said airflow delivery system into said head unit directs adhesive release strips to the bottom of said hollow shape, wherein said airflow further sends said adhesive release strips into said containment system by force of entrained diffused airflow for later disposal.

9. The system of claim 8, wherein said containment system is integrated onto the posterior section of said head unit, wherein said adhesive release strips are contained within said containment system.

10. The system of claim 1, wherein said containment system is selected from the group consisting of: fiber mesh bag, metal mesh bag, box with air holes, bag with air holes, and container with air holes.

11. A method of collecting and containing adhesive release strip waste comprised of:
Forcing high static pressure air into an air intake port,
Channeling said air from said air intake port to interstitial space within a head unit, comprised of an attached plenum and manifold,
Channeling air from said interstitial space within a head unit out through a series of exhaust ports at the top of said manifold,
Transporting a number of adhesive release strip waste by forced air from an opening at the top of said head unit through the bottom of said head unit opening, and
Collecting said adhesive release strip waste within a permeable containment system as said forced air passes through said permeable containment system.

12. The method of claim 11, wherein said containment system is located underneath a work surface, wherein said containment system is permanently fastened to the posterior end of said head unit.

13. The method of claim 11, wherein said containment system is integrated onto said head unit, wherein said containment system is permanently fastened to the posterior end of said head unit.
